(19) United States
(12) Patent Application Publication
(10) Pub. No.: US 2003/0201575 A1
(43) Pub. Date: Oct. 30, 2003

(54) Apparatus and method for rotatably molding a formed millwork product

(76) Inventor: Mohammed Peer Khan, Pittsburgh, PA (US)

Correspondence Address: Michael R. Swartz, Esq., 205 Royal Oak Avenue, Pittsburgh, PA, 15235, US

(21) Appl. No.: 10/135,722

(22) Filed: Apr. 30, 2002

(51) Int. Cl. B29C 41/04

(52) U.S. Cl. 264/310; 425/435

(57) ABSTRACT

An apparatus for rotatably molding a formed millwork product includes lower and upper mold parts for defining a mold cavity therebetween, a support arrangement for rotatably supporting the lower mold part about a longitudinal axis, a clamping arrangement for releasably clamping the mold parts together, a feeding unit for supplying molding material in a liquid form into the mold cavity, a drive unit for rotating the mold parts about the longitudinal axis, and a cooling arrangement for circulating a coolant medium to and from the rotating mold parts so as to control the temperature of the mold parts in view of the exothermic reaction of the molding material in the mold cavity.

### BACKGROUND OF THE INVENTION

1. Field of the Invention

The present invention generally relates to the manufacture of millwork products made of plastic, such as polyurethane, and, more particularly, is concerned with an apparatus and method for rotatably molding pre-formed millwork products, such as balusters, and load bearing and/or non-loading bearing columns, posts, and the like.

2. Description of the Prior Art

Due to the high cost of custom manufacture of wood and the persistent maintenance problems of wood in terms of rotting, cracking, warping, splintering and insect infestation, millwork for entry systems, window treatments, louvers, moldings, balustrades, columns, and architectural enhancements made of plastic, such as polyurethane, is increasingly being utilized in both commercial and residential construction, as well as, in historical restoration. Millwork made of plastic, sometimes referred to as formed or pre-formed millwork, is easy to handle, saws cleanly for miter cuts, and can be applied with construction adhesives and/or nails and screws. Such millwork does not need sanding or sealing and can be patched with ordinary (non-solvent) wood fillers. Furthermore, such millwork is substantially maintenance free in that its white acrylic prime finish will not peel and it is UV-stabilized to resist sun fading and readily accepts latex paint. Such millwork has the feel, density, and workability of wood while avoiding the aforementioned problems associated with wood. For convenience in terminology used hereinafter, the terms millwork, pre-formed millwork, formed millwork, or plastic millwork refer to millwork made of a plastic material, such as polyurethane, and are used interchangeably hereinafter.

U.S. Pat. No. 6,280,178 to Mohammed Peer Khan, who is also the inventor of the present invention, discloses a molding apparatus for producing formed millwork products that has introduced certain innovations advantageous to the millwork manufacturing process, resulting in the achievement of an increase in the production, at lower unit costs, of certain types of millwork products having different shaped profiles. The inventor of this patented molding apparatus has now perceived a need for introduction of further innovations in the millwork manufacturing process. Specifically, this need is for another molding apparatus to produce other types of millwork products, in particular, ones commonly referred to in the industry as balusters and columns.

### SUMMARY OF THE INVENTION

The present invention provides an apparatus and method for rotatably molding a formed millwork product which satisfy the aforementioned need for additional innovation in the millwork manufacturing process. The apparatus and method of the present invention enable an increased production of millwork products, such as balusters and columns, without increasing labor utilization and thus at lower unit costs.

Accordingly, the present invention is directed to an apparatus for rotatably molding a formed millwork product which comprises: (a) a pair of mold parts each defining a portion of a mold cavity and being movable toward and away from one another between mated and unmated relationships with respect to one another so as to correspondingly place the mold cavity portions in closed and opened conditions with respect to one another such that the mold cavity is formed when the mold parts are in the mated relationship with the mold cavity portions in the closed condition; (b) means for supplying a molding material in a liquid form into the mold cavity; (c) means for rotatably supporting at least one of the mold parts about a longitudinal axis such that when the mold parts are in the mated relationship with the mold cavity portions in the closed condition the mold parts can together undergo rotation about the longitudinal axis; (d) means for rotating the mold parts when in the mated relationship so as to provide for substantially uniform distribution of the molding material throughout the mold cavity such that the molding material will expand and substantially uniformly fill the mold cavity due to the occurrence of the expansive nature of an exothermic reaction in the molding material so as to produce a formed millwork product in the mold cavity; (e) means for releasably clamping the mold parts together when in the mated relationship so as to maintain the mold cavity portions in the closed condition as the mold parts are rotated and as the formed millwork product is produced in the mold cavity; and (f) means for circulating a coolant medium to and from the rotating mold parts so as to control the temperature of the mold parts in view of the exothermic reaction of the molding material in the mold cavity.

The present invention also is directed to a method for rotatably molding a formed millwork product which comprises the steps of: (a) providing a pair of mold parts each defining a portion of a mold cavity and being movable toward and away from one another between mated and unmated relationships with respect to one another so as to correspondingly place the mold cavity portions in closed and opened conditions with respect to one another such that the mold cavity is formed when the mold parts are in the mated relationship with the mold cavity portions in the closed condition; (b) placing an elongated central stiffening member on the at least one of the mold parts so as to extend across the mold cavity when the mold parts are in the mated relationship; (c) moving the mold parts relative to one another and into the mated relationship such that the mold cavity portions are placed in the closed condition forming the mold cavity between the mold parts; (d) supplying a molding material in a liquid form from exteriorly of to within the mold cavity when the mold parts are in the mated relationship; (e) rotatably supporting at least one of the mold parts about a longitudinal axis such that when the mold parts are in the mated relationship with the mold cavity portions in the closed condition the mold parts can together undergo rotation about the longitudinal axis; (f) rotating the mold parts together when in the mated relationship so as to provide for substantially uniform distribution of the molding material throughout the mold cavity and about the central stiffening member such that the molding material will expand and substantially uniformly fill the mold cavity due to the occurrence of the expansive nature of an exothermic reaction in the molding material so as to produce a formed millwork product in the mold cavity which incorporates the central stiffening member; (g) releasably clamping the mold parts together when in the mated relationship so as to maintain the mold cavity portions in the closed condition as the mold parts are rotated and as the formed millwork product is produced in the mold cavity; and (h) circulating a coolant medium to and from the rotating mold parts so as to control the temperature of the mold parts in view of the exothermic reaction of the molding material in the mold cavity.

These and other features and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

In the following detailed description, reference will be made to the attached drawings in which:

FIG. 1 is a top plan view of an apparatus of the present invention for rotatably molding a formed millwork product made of plastic.

FIG. 2 is a front elevational view of the apparatus, showing a pair of hingedly connected mold parts of the molding apparatus in a mated relationship to one another.

FIG. 3 is an end elevational view of the apparatus as seen along line 3--3 of FIG. 1.

FIG. 4 is an opposite end elevational view of the apparatus as seen along line 4--4 of FIG. 1.

FIG. 5 is an enlarged side elevational view of one of a pair of hinges that hingedly connect the mold parts of the apparatus to one another.

FIG. 6 is another top plan view of the apparatus, now showing its mold parts in an unmated relationship to one another and before placement into a lower one of the mold parts of a central stiffening member for incorporating into the formed millwork product.

FIG. 7 is still another top plan view of the apparatus, now showing its mold parts in the same relationship as in FIG. 6 but after placement of the central stiffening member into the lower one of the mold parts.

FIG. 8 is a yet another top plan view of the apparatus, now showing its lower and upper mold parts in the same relationship as shown in FIGS. 6 and 7 but after the formed millwork product has been produced by the apparatus when its lower and upper mold parts are in the mated relationship as shown in FIGS. 1 and 2.

FIG. 9 is a side elevational view of the central stiffening member by itself.

FIG. 10 is a side elevational view of one type of the formed millwork product produced by the apparatus when its lower and upper mold parts are in the mated relationship as shown in FIGS. 1 and 2.

FIG. 11 is a longitudinal sectional view of the formed millwork product taken along line 11--11 of FIG. 10.

### DETAILED DESCRIPTION OF THE INVENTION

In the following description, like reference characters designate like or corresponding parts throughout the several views of the drawings. Also in the following description, it is to be understood that such terms as “forward”, “rearward”, “left”, “right”, “upwardly”, “downwardly”, and the like are words of convenience and are not to be construed as limiting terms.

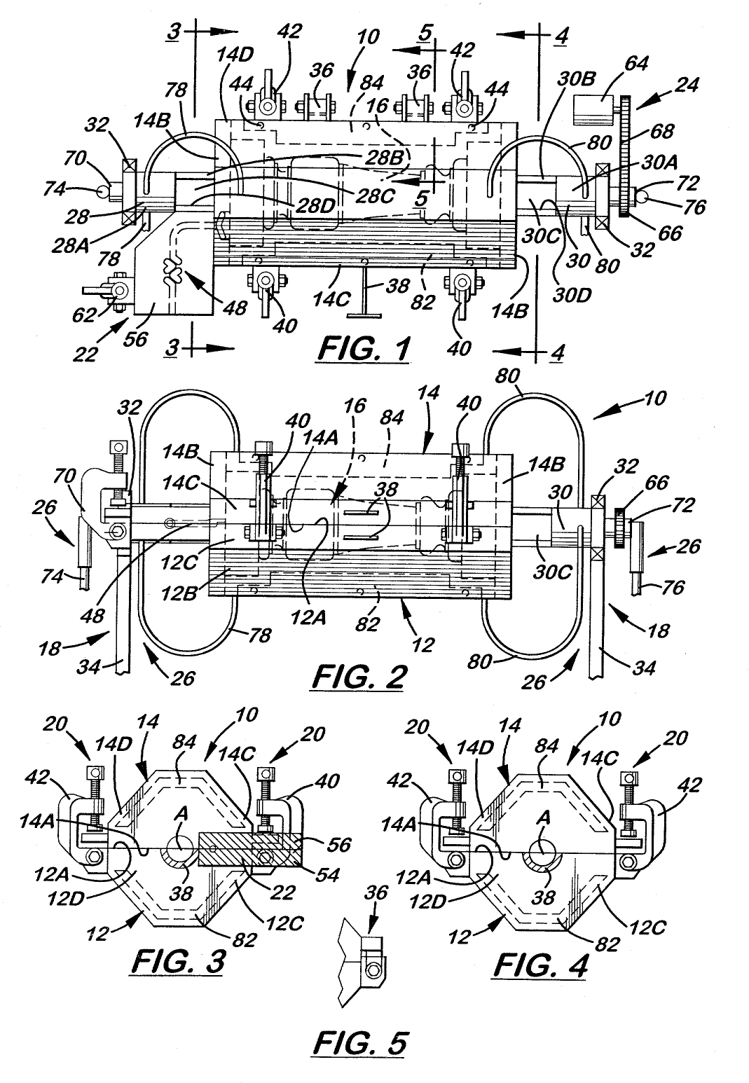

Referring to the drawings and particularly to FIGS. 1 and 2, there is illustrated an apparatus of the present invention, generally designated 10, for rotatably molding a formed millwork product, such as a baluster B (or other load bearing column), as best seen in FIGS. 10 and 11. The rotatable molding apparatus 10 of the present invention basically includes lower and upper mold parts 12, 14 for defining a mold cavity 16 therebetween, a support arrangement 18 for rotatably supporting at least one of the mold parts 12, 14, and preferably the lower mold part 14, about a longitudinal axis A, a clamping arrangement 20 for releasably clamping the mold parts 12, 14 together, a feed unit 22 for supplying molding material in a liquid form into the mold cavity 16, a drive unit 24 for rotating the mold parts 12, 14 about the longitudinal axis A, and a cooling arrangement 26 for circulating a coolant medium to and from the rotating mold parts 12, 14 so as to control the temperature of the mold parts 12, 14 in view of the exothermic reaction of the molding material in the mold cavity 16.

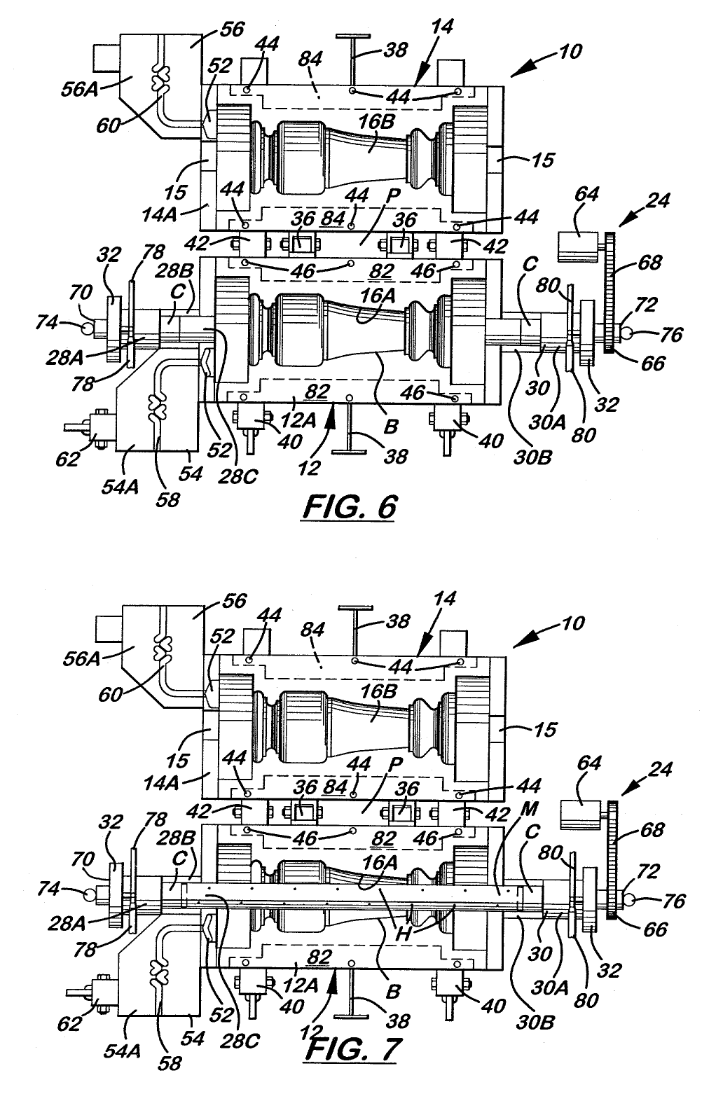

Referring to FIGS. 1-4 and 6-8, the lower and upper mold parts 12, 14 of the apparatus 10 form therein respective mold cavity portions 16A, 16B of the mold cavity 16 and are movable toward and away from one another between a mated relationship with respect to one another, as seen in FIGS. 1 and 2, and an unmated relationship with respect to one another, as seen in FIGS. 6-8. The lower and upper mold parts 12, 14 have respective upper and lower facing surfaces 12A, 14A which surround the respective mold cavity portions 16A, 16B and are disposed in a flush contacting and preferably sealing relationship with one another when the lower and upper mold parts 12, 14 are placed in the mated relationship. Thus, the respective mold cavity portions 16A, 16B are recessed into the mold parts 12, 14 from the respective upper and lower facing surfaces 12A, 14A thereof. When the lower and upper mold parts 12, 14 are placed in their mated and unmated relationships, their respective mold cavity portions 16A, 16B are correspondingly placed in a closed condition with respect to one another, as seen in FIGS. 1 and 2, and an opened condition with respect to one another, as seen in FIGS. 6-8. The mold cavity 16 is thereby formed by the mold parts 12, 14 when they are placed in their mated relationship and the mold cavity portions 16A, 16B are placed in their closed condition. As seen in FIGS. 3 and 4, by way of example only, the mold parts 12, 14 individually have generally similar triangular cross-sectional configurations with three truncated or flat corners such that the mold parts 12, 14 when placed in the mated relationship together have a generally square cross-sectional configuration with four truncated or flat corners.

Each of the mold parts 12, 14 includes a pair of opposite ends 12B, 14B and a pair of opposite front and rear sides 12C, 14C and 12D, 14D. One of the mold parts 12, 14, and preferably the lower mold part 12, includes a pair of elongated rigid rod-shaped extensions 28, 30 being attached to and extending respectively in opposite directions from the opposite ends 12B of the lower mold part 12 and also extend in coaxial relationship with the longitudinal axis A. The extensions 28, 30 have respective outer end portions 28A, 30A and respective inner end portions 28B, 30B extending between the outer end portions 28A, 30A and the opposite ends 12B of the lower mold part 12 and defining respective bores 28C, 30C in flow communication with the opposite ends of the mold cavity portion 16A of the lower mold part 12. The respective inner end portions of the extensions 28, 30 also have semi-cylindrical configurations defining openings 28D, 30D to the bores 28C, 30D which extend between the outer end portions 28A, 30A and opposite ends 12B of the lower mold part 12 and the corresponding opposite ends of the lower mold cavity portion 16A. The respective openings 28D, 30D permit the placement of an elongated central stiffening mandrel or member M (such as a load bearing steel pipe) into the bores 28C, 30C of the extensions 28, 30 and in a coaxial relationship with the longitudinal axis A, such that the central stiffening member M will extend across the lower mold cavity portion 16A of the lower mold part 12 for incorporating the central stiffening member M into the formed millwork product B produced in the mold cavity 16. The member M may also include end caps C thereon to fill excess space in the bores 28C, 30C. Also, as best seen in FIGS. 6-8, a semi-cylindrical recess 15 is formed on the lower facing surface 14A on each of the opposite ends 14B of the upper mold part 14. When the mold parts 12, 14 are placed in their mated relationship, each recess 15 on the opposite ends 14B of the upper mold part 14 extends partially around the corresponding ends of the stiffening member M.

Referring to FIGS. 1, 2 and 6-8, the support arrangement 20 of the apparatus 10, which rotatably supports the lower mold part 12 about the longitudinal axis A, includes a pair of bearings 32 and a pair of frame members 34. Each of the bearings 32 are rotatably mounted to the outer end portion 28B, 30B of a respective one of the extensions 28, 30. Each of the frame members 34 stationarily supports a respective one of the bearings 32. When the mold parts 12, 14 are in their mated relationship and the mold cavity portions 16A, 16B in their closed condition, the mold parts 12, 14 can together undergo rotation about the longitudinal axis A and relative to the bearings 32 and frame members 34. The mold parts 12, 14 preferably are hingedly connected to one another by hinges 36 attached on the rear sides 12D, 14D of the mold parts 12, 14 so as to permit pivotal movement of the upper mold part 14 relative to the lower mold part 12 about a pivotal axis P. The mold parts 12, 14 further have respective handles 38 attached to and extending forwardly of the respective front sides 12C, 14C of the mold parts 12, 14. The handles 38 are gripped by an operator to facilitate pivotally moving the upper mold part 14 relative to the lower mold part 12. As shown, each mold part 12, 14 has only one handle 38 associated with it, however, where the apparatus 10 is longer in length so as to form a long column, preferably more than one handle 38 is associated with each of the mold parts 12, 14.

Referring to FIGS. 1-8, the clamping arrangement 24 of the apparatus 10 includes pairs of front and rear clamps 40, 42. The front clamps 40 are pivotally mounted to the front side 12C of the lower mold part 12 and engageable with the front side 14C of the upper mold part 14. The rear clamps 42 are pivotally mounted to the rear side 12D of the lower mold part 12 and are engageable with the rear side 14D of the upper mold part 14. The front and rear clamps 40, 42 are actuatable for releasably clamping the upper mold part 14 downwardly against the lower mold part 12 into the mated relationship and their respective upper and lower facing surfaces 12A, 14A in the flush contacting relationship so as to maintain the mold cavity portions 16A, 16B in the closed condition as the mold parts 12, 14 are rotated together about the longitudinal axis A and as the formed millwork product B is produced in the mold cavity 16 about its central stiffening member M. The specific number of clamps 40, 42 is not critical, but rather, depends, more or less, upon the length of the product B being formed by the apparatus 10. Furthermore, the upper mold part 14 has a plurality of spaced apart alignment pins 44 attached to and projecting downwardly from its lower facing surface 14A adjacent to the front and rear sides 14C, 14D thereof. The lower mold part 12 has a plurality of spaced apart alignment holes 46 defined in its facing surface 12A adjacent to the front and rear sides 12C, 12D thereof and adapted to receive the alignment pins 44 when the lower and upper mold parts 12, 14 are moved into their closed relationship.

Referring to FIGS. 1-3 and 6-8, the feed unit 18 of the apparatus 10 is provided for supplying the molding material in a liquid form into the mold cavity 16 when the lower and upper mold parts 12, 14 have been pivotally moved into their mated relationship. The feed unit 18 defines a passage 48 extending in flow communication from exteriorly of to within the mold cavity 16 when the lower and upper mold parts 12, 14 are in their mated relationship. The feed unit 18 is shown being located at one end of the apparatus 10, however, it could be located at any location along the apparatus 10. If the product to be formed is a long column, preferably the feed unit 18 would be located at the midpoint or center of the apparatus 10. More particularly, the feed unit 18 includes a pair of first formations 50, 52 defined on the facing surfaces 12A, 14A of the lower and upper mold parts 12, 14. The first formations 50, 52 take the form of raised and recessed features which together form a first portion of the passage 48 which extends between the lower and upper mold parts 12, 14 to the mold cavity 16 when the mold parts 12, 14 are in their mated relationship. The feed unit 18 also includes lower and upper plates 54, 56 being removably attached to the respective upper and lower mold parts 12, 14 adjacent to the facing surfaces 12A, 14A thereof. The lower and upper plates 54, 56 have respective upper and lower facing sides 54A, 56A which are disposed in a flush contacting relationship with one another when the lower and upper mold parts 12, 14 are in the mated relationship. The feed unit 18 further includes a pair of second formations 58, 60 defined on the upper and lower facing sides 54A, 56A of the lower and plates 54, 56. The second formations 58, 60 take the form of raised and recessed features which together form a second portion of the passage 48 which extends between the lower and upper plates 54, 56 from exteriorly of the plates 54, 56 to and in flow communication with the first portion of the passage 48 when the facing sides 54A, 56A of the plates 54, 56 are in their flush contacting relationship. Still further, the feed unit 18 includes a clamp 62 actuatable to releasably clamp the plates 54, 56 together when the mold parts 12, 14 are in their mated relationship such that the facing sides 54A, 56A of the plates 54, 56 are maintained in their flush contacting relationship. After the upper and lower mold parts 12, 14 have been placed and clamped in their mated relationship, a set amount of molding material is injected in the mold cavity 16 via the passage 48. Then, the feed unit 18 is removed and the first portion of the passage 48 is plugged.

Referring to FIGS. 1, 2 and 6-8, the drive unit 24 of the apparatus 10 is capable of rotating the mold parts 12, 14 when in their mated relationship so that the molding material in the mold cavity 16 will become substantially uniformly distributed throughout the mold cavity 16 and will expand and substantially uniformly fill the mold cavity 16 due to the occurrence of the expansive nature of an exothermic reaction in the molding material so as to produce the formed millwork product B in the mold cavity 16, with the product B incorporating the stiffening member M. More particularly, the drive unit 24 includes a drive motor 64 that produces rotary motion, a gear or sprocket 66 fixedly attached over the outer end portion 30A of the one extension 30, and a flexible element 68, such as a flexible chain, extending between and drivingly interconnecting the drive motor 64 and the sprocket 66 on the outer end portion 30A of the one extension 30 so as to transmit rotary motion to the mold parts 12, 14 via the one tubular extension 30.

Referring to FIGS. 1, 2 and 6-8, the cooling arrangement 26 of the apparatus 10 supplies a coolant medium to the rotating mold parts 12, 14 so as to control the temperature of the mold parts 12, 14 in view of the exothermic reaction of the molding material in the mold cavity. More particularly, the cooling arrangement 26 includes a pair of swivel members 70, 72, inlet and outlet lines 74, 76 and first and second pairs of flow lines 78, 80. The swivel members 70, 72 are rotatably mounted to respective outer end portions 28A, 30A of the extensions 28, 30. The inlet line 74 is connected in flow communication with the one swivel member 70 for transferring the coolant medium into the one swivel member 70. The outlet line 76 is connected in flow communication with the other swivel member 72 for transferring the coolant medium from the other swivel member 72. The first pair of flow lines 78 extend between and are connected in flow communication with the one swivel member 70 and with respective coolant medium chambers 82, 84 defined in the respective mold parts 12, 14 adjacent to but isolated from the respective mold cavity portions 16A, 16B of the mold parts 12, 14. The first pair of flow lines 78 thereby transfer the coolant medium from the one swivel valve 70 to the coolant medium chambers 82, 84 of the mold parts 12, 14. The second pair of flow lines 80 extend between and are connected in flow communication with the other swivel member 72 and the respective coolant medium chambers 82, 84 of the mold parts 12, 14. The second pair of flow lines 80 thereby transfer the coolant medium from the coolant medium chambers 82, 84 of the mold parts 12, 14 to the other swivel member 72. Also not shown but connected between the inlet and outlet lines 74, 76 is a pump and heat exchanger for pumping and controlling the temperature of the coolant medium, for example maintaining the temperature of water at 140 degrees F.

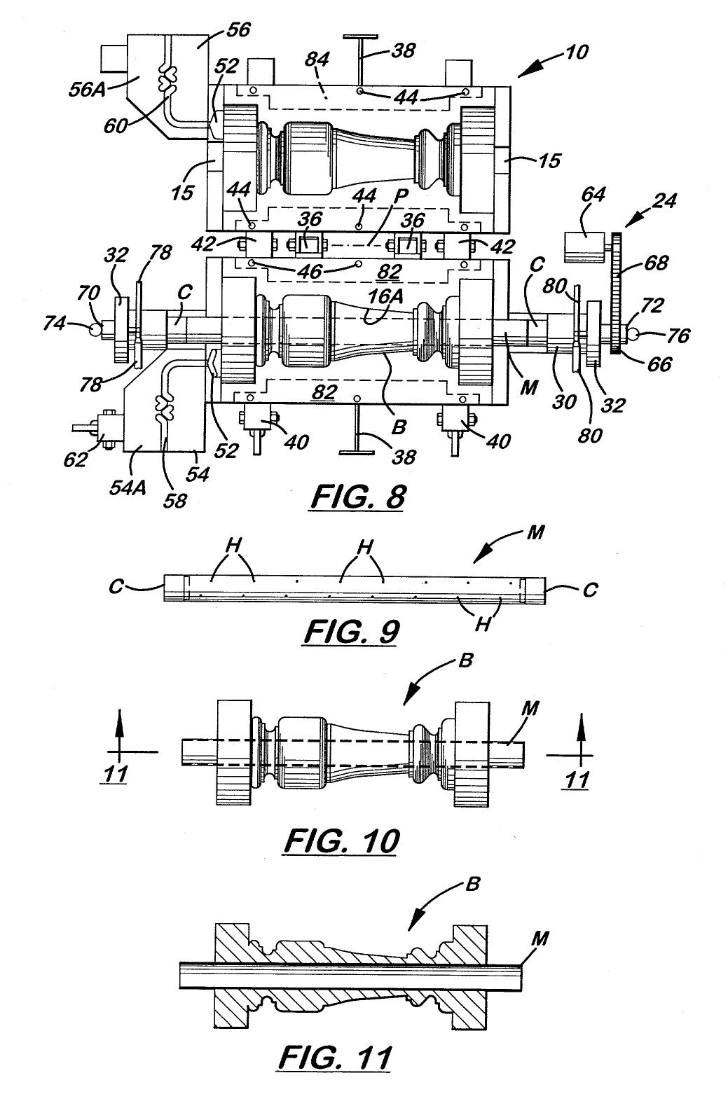

The rotatable molding apparatus 10 is operated as follows to perform the method of the present invention and to produce the formed millwork product B. First, using the handles 38 the upper and lower mold parts 12, 14 are pivoted relative to and away from one another so as to place them in their unmated relationship of FIG. 6. Next, as seen in FIG. 7, the elongated central stiffening member M is placed in the bores 28C, 30C of the extensions 28, 30 and across the mold cavity portion 16A of the lower mold part 12. The mold parts 12, 14 are then moved relative to and toward one another to place them in their mated relationship, as shown in FIGS. 1 and 2, such that the mold cavity portions 16A, 16B are placed in the closed condition forming the mold cavity 16 between the mold parts 12, 14. Now, the operator actuates the front and rear clamps 40, 42 on the mold parts 12, 14 and also the clamp 62 of the feed unit 22 to maintain the mold parts 12, 14 in the mated relationship and the plates 54, 56 of the feed unit 22 in their flush contacting relationship. A predetermined quantity of molding material is forceably fed through the passage 48 of the feed unit 22 into the mold cavity 16. The feed unit 18 is then removed and the first portion of the passage 48 leading to the mold cavity 16 is plugged. As coolant medium is circulated through the mold parts 12, 14 by the cooling arrangement 26, the mold parts 12, 14 are rotated by the drive unit 22 until the formed millwork product B incorporating the central stiffening member M is molded in the mold cavity 16. Also, during the molding operation, gas produced by the exothermic reaction of the molding material is evacuated through a plurality of holes H defined in the central stiffening member M, as seen in FIG. 9, and externally outwardly through the small gap or space between the mated lower and upper mold parts 12, 14. Once the molding of the product B is finished the clamps 40, 42 and 62 are released and the mold parts 12, 14 are moved to their unmated relationship, as seen in FIG. 8, and the product B is now accessible for removal by the operator from the apparatus 10.

It is thought that the present invention and its advantages will be understood from the foregoing description and it will be apparent that various changes may be made thereto without departing from the spirit and scope of the invention or sacrificing all of its material advantages, the form hereinbefore described being merely preferred or exemplary embodiment thereof.

I claim:

1. An apparatus for rotatably molding a formed millwork product, comprising:
(a) a pair of mold parts each defining a portion of a mold cavity and being movable toward and away from one another between mated and unmated relationships with respect to one another so as to correspondingly place said mold cavity portions in closed and opened conditions with respect to one another such that said mold cavity is formed when said mold parts are in said mated relationship with said mold cavity portions in said closed condition;
(b) means for supplying a molding material in a liquid form into said mold cavity;
(c) means for rotatably supporting at least one of said mold parts about a longitudinal axis such that when said mold parts are in said mated relationship with said mold cavity portions in said closed condition said mold parts can together undergo rotation about said longitudinal axis;
(d) means for rotating said mold parts when in said mated relationship so as to provide for substantially uniform distribution of the molding material throughout said mold cavity such that the molding material will expand and substantially uniformly fill said mold cavity due to the occurrence of the expansive nature of an exothermic reaction in the molding material so as to produce a formed millwork product in said mold cavity;
(e) means for releasably clamping said mold parts together when in said mated relationship so as to maintain said mold cavity portions in said closed condition as said mold parts are rotated and as the formed millwork product is produced in said mold cavity; and
(f) means for circulating a coolant medium to and from said rotating mold parts so as to control the temperature of said mold parts in view of the exothermic reaction of the molding material in said mold cavity.

2. The apparatus as recited in claim 1, wherein said means for supplying the molding material defines a passage extending in flow communication from exteriorly of to within said mold cavity when said mold parts are in said mated relationship.

3. The apparatus as recited in claim 2, wherein said means for supplying the molding material includes:
a pair of first formations defined on facing surfaces of said mold parts, said first formations together forming a first portion of said passage which extends between said mold parts to said mold cavity when said mold parts are in said mated relationship;
a pair of plates each removably attached to a respective one of said mold parts adjacent to said facing surfaces of said mold parts, said plates having respective facing sides which are disposed in a flush contacting relationship with one another when said mold parts are in said mated relationship; and
a pair of second formations defined on said facing sides of said plates, said second formations together forming a second portion of said passage which extends between said plates from exteriorly of said plates to and in flow communication with said first portion of said passage when said facing sides of said plates are in said flush contacting relationship.

4. The apparatus as recited in claim 3, wherein said means for supplying the molding material further includes a clamp for releasably clamping said plates together when said mold parts are in said mated relationship such that said facing sides of said plates are maintained in said flush contacting relationship.

5. The apparatus as recited in claim 1, wherein one of said mold parts includes a pair of opposite ends and a pair of extensions attached to and extending respectively in opposite directions from said opposite ends of said one mold part and coaxially with said longitudinal axis, each of said extensions having an outer end portion.

6. The apparatus as recited in claim 5, wherein each of said extensions of said one mold part further has an inner end portion defining a bore in flow communication with one of said opposite ends of said mold cavity portion of said one mold part, said inner end portion having a semi-cylindrical configuration defining an opening to said bore which extends between said outer end portion and one of said opposite ends of said mold cavity portion of said one mold part so as to permit placement of an elongated central stiffening member into said bores of said extensions and extending across said mold cavity portion of said one mold part for incorporating the central stiffening member into the formed millwork product produced in said mold cavity.

7. The apparatus as recited in claim 5, wherein said means for rotatably supporting said one mold part includes:
a pair of bearings each rotatably mounted to said outer end portion of a respective one of said extensions of said one mold part; and
a pair of frame members each stationarily supporting a respective one of said bearings.

8. The apparatus as recited in claim 5, wherein said means for rotating said mold parts includes:
a drive unit that produces rotary motion; and
an arrangement extending between and drivingly interconnecting said drive unit and said outer end portion of one of said extensions of said one mold part so as to transmit rotary motion to said mold parts via said one extension.

9. The apparatus as recited in claim 5, wherein said means for circulating the coolant medium to and from said rotating mold parts includes:
a pair of swivel members each rotatably mounted to said outer end portion of a respective one of said extensions of said one mold part;
a inlet line connected in flow communication with one of said swivel members for transferring the coolant medium into the one of said swivel members; and
an outlet line connected in flow communication with the other of said swivel members for transferring the coolant medium from the other of said swivel members.

10. The apparatus as recited in claim 9, wherein said means for circulating the coolant medium to and from said rotating mold parts also includes:
a first pair of flow lines extending between and connected in flow communication with the one of said swivel members and with respective coolant medium chambers defined in said respective mold parts adjacent to but isolated from said respective mold cavity portions of said mold parts such that said first pair of flow lines transfer the coolant medium from the one of said swivel members to said coolant medium chambers of said mold parts; and
a second pair of flow lines extending between and connected in flow communication with the other of said swivel members and said respective coolant medium chambers of said respective mold parts such that said second pair of flow lines transfer the coolant medium from said coolant medium chambers of said mold parts to the other of said swivel members.

11. The apparatus as recited in claim 1, wherein:
each of said mold parts has opposite front and rear sides; and
said means for releasably clamping said mold parts together includes a pair of clamps mounted to at least one of said mold parts at each of said front and rear sides and being actuatable for releasably clamping the other of said mold parts against said one mold part.

12. The apparatus as recited in claim 1, wherein each of said mold parts has opposite front and rear sides and are hingedly connected to one another at said rear sides of said mold parts so as to permit pivotal movement of one of said mold parts relative to the other of said mold parts between said mated and unmated relationships.

13. The apparatus as recited in claim 1, wherein each of said mold parts has opposite front and rear sides and a pair of handles each attached to and extending forwardly of said front side of a respective one of said mold parts.

14. The apparatus as recited in claim 13, wherein one of said mold parts has sets of spaced apart alignment pins mounted from a facing surface of said one mold part adjacent to said front and rear sides thereof and the other of said mold parts has sets of spaced apart alignment holes defined in a facing surface of said other mold part adjacent to said front and rear sides thereof and adapted to receive said alignment pins when said mold parts in said closed relationship.

15. A method for rotatably molding a formed millwork product, comprising the steps of:
(a) providing a pair of mold parts each defining a portion of a mold cavity and being movable toward and away from one another between mated and unmated relationships with respect to one another so as to correspondingly place the mold cavity portions in closed and opened conditions with respect to one another such that the mold cavity is formed when the mold parts are in the mated relationship with the mold cavity portions in the closed condition;
(b) placing an elongated central stiffening member on at least one of the mold parts so as to extend across the mold cavity when the mold parts are in the mated relationship;
(c) moving the mold parts relative to one another and into the mated relationship such that the mold cavity portions are placed in the closed condition forming the mold cavity between the mold parts;
(d) supplying a molding material in a liquid form from exteriorly of to within the mold cavity when the mold parts are in the mated relationship;
(e) rotatably supporting at least one of the mold parts about a longitudinal axis such that when the mold parts are in the mated relationship with the mold cavity portions in the closed condition the mold parts can together undergo rotation about the longitudinal axis;
(f) rotating the mold parts together when in the mated relationship so as to provide for substantially uniform distribution of the molding material throughout the mold cavity and about the central stiffening member such that the molding material will expand and substantially uniformly fill the mold cavity due to the occurrence of the expansive nature of an exothermic reaction in the molding material so as to produce a formed millwork product in the mold cavity which incorporates the central stiffening member;
(g) releasably clamping the mold parts together when in the mated relationship so as to maintain the mold cavity portions in the closed condition as the mold parts are rotated and as the formed millwork product is produced in the mold cavity; and
(h) circulating a coolant medium to and from the rotating mold parts so as to control the temperature of the mold parts in view of the exothermic reaction of the molding material in the mold cavity.

16. The method as recited in claim 15, further comprising the step of:
providing a pair of extensions each attached to and extending respectively in opposite directions from one of a pair of opposite ends of one of the mold parts and coaxially with the longitudinal axis such that each of the extensions has a central bore in flow communication with one of the opposite ends of the mold cavity portion of the one mold part and further has an outer end portion of cylindrical configuration surrounding the central bore.

17. The method as recited in claim 16, further comprising the step of:
providing an inner end portion on each of the extensions of the one mold part with a semi-cylindrical configuration so as to define an opening to the central bore extending between the outer end portion and one of the opposite ends of the mold cavity portion of the one mold part.

18. The method as recited in claim 17, further comprising the step of:
placing the elongated central stiffening member into the central bores of the extensions of the one mold part so as to extend across the mold cavity portion of the one mold part for incorporating the central stiffening member into the formed millwork product produced in the mold cavity.

19. The method as recited in claim 18, further comprising the step of:
evacuating the inherent air and gases produced by the expansive nature of the exothermic reaction of the molding material through a plurality of holes defined in and communicating with a central passage through the central stiffening member.

20. The method as recited in claim 16, further comprising the step of:
rotatably supporting the one mold part at the outer end portions of the extensions thereof and about the longitudinal axis such that when the mold parts are in the mated relationship with the mold cavity portions in the closed condition the mold parts can together undergo rotation about the longitudinal axis.
